(19) United States
(12) Patent Application Publication
(10) Pub. No.: US 2026/0030691 A1
(43) Pub. Date: Jan. 29, 2026

(54) BAYESIAN WELL DECLINE CURVE ESTIMATES FOR PRODUCTION FORECASTING

(71) Applicant: CHEVRON U.S.A. INC., San Ramon, CA (US)

(72) Inventors: Tesia Anne Houlette, Fulshear, TX (US); David James Robbins, Sacramento, CA (US); Scott Harold McKean, Calgary, Alberta (CA); Shane James Prochnow, Fredericksburg, TX (US)

(21) Appl. No.: 19/278,287

(22) Filed: Jul. 23, 2025

Related U.S. Application Data
(60) Provisional application No. 63/674,455, filed on Jul. 23, 2024.

(51) Int. Cl. G06Q 50/02; E21B 41/00; G06Q 10/0639

(52) U.S. Cl. CPC G06Q 50/02; E21B 41/00; G06Q 10/0639

(57) ABSTRACT

Systems and methods are provided for performing decline curve analysis. The system can obtain historical production data as a function of time for at least one well drilled into a reservoir. The data can be smoothed and clustered into at least one cluster corresponding to a region of the reservoir. For the region, the system can generate an initial probability distribution for each decline parameter in a corresponding decline curve model and apply a Bayesian function iteratively to each initial probability distribution to generate a posterior probability distribution for each decline parameter to estimate an expected ultimate recovery (EUR) for each well. The system can generate a graphical representation of each posterior distribution for each well and display the graphical representations on a display.

### REFERENCE TO RELATED APPLICATIONS

The present application claims priority to U.S. Patent Provisional Application No. 63/674,455, filed Jul. 23, 2024 and titled “BAYESIAN WELL DECLINE CURVE ESTIMATES FOR PRODUCTION FORECASTING,” which is incorporated herein by reference in its entirety.

### TECHNICAL FIELD

The present disclosure relates generally to hydrocarbon production, and in particular, some implementations may relate to characterizing subsurface features to estimate hydrocarbon production.

### BACKGROUND

Decline curve analysis is a means of predicting future hydrocarbon production based on past production history. A decline curve illustrates the amount of hydrocarbon recovered over time in the presence of variable conditions. Hydrocarbon wells usually reach their maximum output and begin a decline in production, the rapidity of decline being affected by these variable conditions and other productivity factors. The resulting curve may assist future predictions on how the well or similar wells will perform in the future. Decline curve analysis is important in determining the value of these wells and forecasted productions.

### BRIEF SUMMARY OF THE DISCLOSURE

According to various embodiments of the disclosed technology, a computer-implemented method for performing decline curve analysis may comprise obtaining historical production data as a function of time for at least one well drilled into a reservoir; smoothing the obtained historical production data; clustering the smoothed historical production data into at least one cluster corresponding to a region of the reservoir; for the region, generating an initial probability distribution for each decline parameter in a corresponding decline curve model; applying a Bayesian function iteratively to each initial probability distribution to generate a posterior probability distribution for each decline parameter to estimate an expected ultimate recovery (EUR) for each well; generating a graphical representation of each posterior distribution for each well, wherein the graphical representation indicates uncertainty of each EUR over time; and displaying the graphical representations on a display.

In some embodiments, the method further comprises aggregating a plurality of posterior probability distributions corresponding to a plurality of clusters to generalize an EUR for a region of interest.

In some embodiments, the method further comprises identifying at least one well that experienced fracture driven interaction.

In some embodiments, the method further comprises determining how operational events to the at least one well are affecting well production.

In some embodiments, the method further comprises identifying at least one well that is a candidate for manual examination of its corresponding decline curve.

In some embodiments, the method further comprises identifying at least one well that is statistically not likely to be a candidate for manual examination of its corresponding decline curve.

In some embodiments, the method further comprises quantifying uncertainty for each region.

In some embodiments, the region is based on geology of the reservoir or a spatial cluster analysis of well production.

In some embodiments, the method further comprises identifying a future time interval to update production time data for each region based on changes in uncertainty during the future time interval.

In some embodiments, applying the Bayesian function iteratively to each initial probability distribution involves comparing each initial probability distribution to all initial probability distributions.

According to various embodiments of the disclosed technology, a system for subsurface characterization from seismic gather data may comprise a processor, a display, and a memory encoded with instructions. The instructions, when executed by the processor, may cause the processor to obtain historical production data as a function of time for at least one well drilled into a reservoir; smooth the obtained historical production data; cluster the smoothed historical production data into at least one cluster corresponding to a region of the reservoir; for the region, generate an initial probability distribution for each decline parameter in a corresponding decline curve model; apply a Bayesian function iteratively to each initial probability distribution to generate a posterior probability distribution for each decline parameter to estimate an expected ultimate recovery (EUR) for each well; aggregating a plurality of posterior probability distributions corresponding to a plurality of clusters to generalize an EUR for a region of interest; generate a graphical representation of the aggregated plurality of posterior probability distributions; and display the graphical representations on the display.

In some embodiments, the processor is further configured to determine how operational events to the at least one well are affecting well production.

In some embodiments, the processor is further configured to identify at least one well that is a candidate for manual examination of its corresponding decline curve.

In some embodiments, the processor is further configured to identify at least one well that is statistically not likely to be a candidate for manual examination of its corresponding decline curve.

In some embodiments, the processor is further configured to quantify uncertainty for each region.

In some embodiments, the region is based on geology of the reservoir or a spatial cluster analysis of well production.

According to various embodiments of the disclosed technology, a non-transitory machine-readable storage medium may be encoded with instructions, which when executed by a processor, may cause the processor to obtain historical production data as a function of time for at least one well drilled into a reservoir; smooth the obtained historical production data; cluster the smoothed historical production data into at least one cluster corresponding to a region of the reservoir; for the region, generate an initial probability distribution for each decline parameter in a corresponding decline curve model; apply a Bayesian function iteratively to each initial probability distribution to generate a posterior probability distribution for each decline parameter to estimate an expected ultimate recovery (EUR) for each well; quantify uncertainty for each posterior probability distribution; generate a graphical representation of each posterior distribution and its uncertainty for each well; and display the graphical representations on a display.

In some embodiments, the processor is further configured to identify at least one well that is a candidate for manual examination of its corresponding decline curve.

In some embodiments, the processor is further configured to identify at least one well that is statistically not likely to be a candidate for manual examination of its corresponding decline curve.

In some embodiments, the region is based on geology of the reservoir or a spatial cluster analysis of well production.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example system in accordance with the embodiments described herein.

FIGS. 2A-2B illustrate graphical representations of resulting decline curves, in accordance with one embodiment.

FIG. 3 illustrates an example graphical representation of updated decline curves in accordance with the systems and methods described herein.

FIGS. 4A-4B illustrate an example method in accordance with the embodiments described herein.

FIG. 5 is an example computing component that may be used to implement various features of embodiments described in the present disclosure.

The figures are not exhaustive and do not limit the present disclosure to the precise form disclosed.

### DETAILED DESCRIPTION

Traditional methods of approaching decline curve analyses may involve manual, subjective, and tedious processes undertaken by subsurface production engineers during the yearly reserves cycle. Some traditional systems manually update estimated ultimate recovery (EUR) for each well, up to tens of thousands of wells depending on inventory. Manually updating thousands of wells in this manner may lead to inconsistencies and delays in well maintenance and hydrocarbon production efforts. Additionally, traditional systems performing decline curve analysis do not test for statistical significance against uncertainty (in part because analysis for each well is manually updated). Ignoring these statistics may also lead to inconsistencies in manually updating information for thousands of wells.

The systems and embodiments described herein may forecast EUR and b-factor (decline slope) uncertainty that may be used to determine the statistical significance of a distribution of forecasts. Embodiments may employ parametric statistical tests to determine statistically significant differences between well parameters for each well or between temporal segments of a well before and after a treatment event. Traditional systems evaluate one well at a time and fit a decline curve to the one well. These curves may be updated after an engineer evaluates a neighboring or related curve. Because the engineer has to go back and update curves after evaluating one or more later curves, a particular well's curve may need to be updated hundreds of times before the analysis is finally completed. In contrast, the systems and embodiments described herein may evaluate all wells at once when determining a decline curve for a particular well, which may eliminate thousands of hours of time and effort required to produce statistically significant EUR updates required in reserves planning.

Embodiments employ a Bayesian statistical approach to automate decline curve analyses. The Bayesian approaches may include “prior distributions” or foundational curve information which may be informed by previous experiments or testing events. Bayes' theorem may be applied to prior distributions to compute and update probabilities after obtaining new data. Bayes' theorem may be represented by the following equation:

$$p ( θ \vert y ) \approx p ( θ ) L ( y \vert θ )$$

where p(θ|y) refers to the posterior parameter distribution, θ refers to Arps Model parameters, y refers to the observed well data, p(θ) refers to the prior parameter distribution, and L(y|θ) refers to a likelihood function.

Bayes' theorem describes the conditional probability of an event based on data as well as prior information about the event or conditions related to the event. Bayes' theorem may directly assign a probability distribution that quantifies the belief to the parameter or set of parameters.

Prior distributions may be informed by subject matter expert (SME) data. The initial factors and parameters may be derived either from distributions observed in manual decline inventories or from other machine learning models that predict these variables from production, engineering and/or subsurface predictors, such as completion size and reservoir. All possible combinations of the prior distributions may be included when evaluating all wells. Wells may be sorted into clusters that correspond to different flow regimes using rate data to discern patterns and groupings within the data that may indicate different stages or types of flow. Affected parameters may include the initial flow of the well, the initial decline, the minimum decline, and/or a deceleration factor for the well. Here, the initial flow or decline refers to a well's rate of flow or decline on the first day of testing or analysis. These parameters may be pooled into a local and/or global hierarchy for purposes of clustering the wells. The production time may be transformed or normalized as required to fit the data more accurately. The data fitting may be performed using machine learning or Markov Chain Monte Carlo approaches to minimize residual or outlying points after calculating the sum of squares. The normalized data may be used to compute decline curves from one or more starting points. Markov Chain Monte Carlo approaches may involve merging probability distributions by sampling from each distribution and combining the samples to obtain a merged distribution that represents the average of the two distributions.

The systems and methods described herein may improve conventional decline curve analyses by effectively determining uncertainty in single well decline curve forecasts, which may enable more accurate hydrocarbon resource and reserves estimates for a hydrocarbon producing field. These generated uncertainties may also be refined to inform future parametric and non-parametric statistical tests, such as t-tests. These statistical tests may help discern if a “Enhanced Oil Recovery” (EOR) treatment to a well or any well changes may provide statistically significant changes in EUR.

These systems and embodiments may improve the efficiency of hydrocarbon production by providing a more accurate representation of depth uncertainty in a subsurface area of interest. This improved display allows for the presentation and consumption of information in a unique manner that enables personnel to immediately have the information they need to accurately and quickly identify how to best utilize a hydrocarbon well. The speed and ease of using this display greatly reduces the time it takes to analyze decline curves for thousands of wells, which is already a lengthy process. Rather than providing a rough and manual estimate of a well's efficacy, this display greatly improves accuracy of decline curve analyses and provides personnel with immediate information on important well planning decisions.

A “well” or a “wellbore” refers to a single hole, usually cylindrical when viewed in at least piecewise increments, that is drilled into a reservoir. A well may be drilled in one or more directions. For example, a well may include a vertical well or section of the well, a horizontal well or section of the well, a deviated well or section of the well, and/or other type of well or section of the well. A well may be drilled in the reservoir for exploration and/or recovery of resources. A plurality of wells (e.g., tens to hundreds of wells) or a plurality of well are often used in a field depending on the desired outcome.

A well may be drilled into a reservoir using practically any drilling technique and equipment known in the art, such as geosteering, directional drilling, etc. Drilling the well may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well. The equipment to be used in drilling the well may be dependent on the design of the well, the reservoir, the hydrocarbons and/or other subsurface resources being produced, and/or other factors.

A well may include a plurality of components, including but not limited to a casing, a liner, a tubing string, a sensor, a packer, a screen, a gravel pack, artificial lift equipment (e.g., an electric submersible pump (ESP)), and/or other components. If a well is drilled offshore, the well may include one or more of the previous components plus other offshore components, such as a riser. A well may also include equipment to control fluid flow into the well, control fluid flow out of the well, or any combination thereof. For example, a well may include a wellhead, a choke, a valve, and/or other control devices. These control devices may be located on the surface, in the subsurface (e.g., downhole in the well), or any combination thereof.

In some embodiments, the same control devices may be used to control fluid flow into and out of the well. In some embodiments, different control devices may be used to control fluid flow into and out of a well. In some embodiments, the rate of flow of fluids through the well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well may also include any completion hardware that is not discussed separately. The term “well” may be used synonymously with the terms “borehole,” “wellbore,” or “well bore.” The term “well” is not limited to any description or configuration described herein.

“Hydraulic fracturing” is one way that hydrocarbons may be recovered (sometimes referred to as produced) from a reservoir (e.g., having a permeability of less than. 0.1 mD) in an economic manner. For example, hydraulic fracturing may entail preparing a fracturing fluid and injecting that fracturing fluid into the well at a sufficient rate and pressure to open existing fractures and/or create fractures in the reservoir. The fractures permit hydrocarbons to flow more freely into the well. In the hydraulic fracturing process, the fracturing fluid may be prepared on-site to include at least proppants. The proppants, such as sand or other particles, are meant to hold the fractures open so that hydrocarbons may more easily flow to the well. The fracturing fluid and the proppants may be blended together using at least one blender. The fracturing fluid may also include other components in addition to the proppants.

The well and the reservoir proximate to the well are in fluid communication (e.g., via perforations), and the fracturing fluid with the proppants is injected into the well through a wellhead of the well using at least one pump (oftentimes called a fracturing pump). The fracturing fluid with the proppants is injected at a sufficient rate and pressure to open existing fractures and/or create fractures in the reservoir. As fractures become sufficiently wide to allow proppants to flow into those fractures, proppants in the fracturing fluid are deposited in those fractures during injection of the fracturing fluid. After the hydraulic fracturing process is completed, the fracturing fluid is removed by flowing or pumping it back out of the well so that the fracturing fluid does not block the flow of hydrocarbons to the well. The hydrocarbons may enter the same well from the reservoir and go up to the surface for further processing. The hydrocarbons may enter a different well drilled into the reservoir, such as in the event of fracture driven interaction (FDI), and go up to the surface for further processing.

The equipment to be used in preparing and injecting the fracturing fluid may be dependent on the components of the fracturing fluid, the proppants, the well, the reservoir, etc. However, for simplicity, the term “fracturing apparatus” is meant to represent any tank(s), mixer(s), blender(s), pump(s), manifold(s), line(s), valve(s), fluid(s), fracturing fluid component(s), proppants, and other equipment and non-equipment items related to preparing the fracturing fluid and injecting the fracturing fluid.

The term “hydrocarbon” refers to a compound containing carbon and hydrogen atoms. Hydrocarbons may include liquid hydrocarbons (also known as oil or petroleum), gas hydrocarbons, a combination of liquid hydrocarbons and gas hydrocarbons (e.g., including gas condensate), etc. For simplicity, many examples in this disclosure relate to production of hydrocarbons. However, this disclosure applies to other produced fluid (e.g., produced water from a well, produced water from multiple wells, etc.), such as produced fluid in a liquid phase, produced fluid in a gas phase, or produced fluid in a combination of liquid phase and gas phase.

A “reservoir” refers to a subsurface rock matrix in which a wellbore may be drilled. For example, a reservoir refers to a body of rock that is sufficiently distinctive and continuous such that it can be mapped. A reservoir stores resources, such as hydrocarbons, in its pore space. Reservoirs may vary in geologic features, such as, but not limited to, porosity, mineralogy, geomechanics, permeability, fluid saturation, presence of fractures, geologic structure (e.g., folds, manipulated by tectonic processes), thermal maturity, diagenic alterations, etc. As used herein, in some embodiments, a reservoir may have a permeability of nanodarcy permeability to millidarcy permeability. As used herein, the term “region” of a reservoir refers to a continuous subdivision of reservoir based on some criteria, such as, but not limited to, porosity, mineralogy, geomechanics, permeability, fluid saturation, presence of fractures, geologic structure (e.g., folds, manipulated by tectonic processes), thermal maturity, diagenic alterations, etc.

As used herein, in some embodiments, a reservoir may have a permeability of less than 0.1 millidarcy (mD) (e.g., 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, or 0.000001 mD or less). As used herein, in some embodiments, a reservoir may have a permeability of at least 0.0000001 mD (e.g., at least 0.000005 mD, at least 0.00001 mD, at least 0.00005 mD, at least 0.0001 mD, at least 0.0005 mD, at least 0.0001 mD, at least 0.005 mD, at least 0.01 mD, or at least 0.05 mD). A reservoir may have a permeability ranging from any of the minimum values described above to any of the maximum values described above. As used herein, in some embodiments, a reservoir may have a permeability from 0.0000001 mD to 0.1 mD, e.g., from 0.0000001 mD to 0.001 mD or 0.0000001 mD to 0.01 mD.

As used herein, in some embodiments, a reservoir may have a permeability higher than 25 millidarcy (mD). As used herein, in some embodiments, a reservoir may have a permeability of at least 26 mD (e.g., at least 50 mD, at least 100 mD, at least 200 mD, at least 300 mD, at least 400 mD, at least 500 mD, at least 600 mD, at least 700 mD, at least 800 mD, at least 900 mD, at least 1,000 mD, at least 1,500 mD, at least 2,000 mD, at least 2,500 mD, at least 3,000 mD, at least 3,500 mD, at least 4,000 mD, at least 4,500 mD, at least 5,000 mD, at least 5,500 mD, at least 6,000 mD, at least 6,500 mD, at least 7,000 mD, at least 7,500 mD, at least 8,000 mD, at least 8,500 mD, at least 9,000 mD, or at least 9,500 mD). For example, as used herein, in some embodiments, a reservoir may have a permeability of from 26 mD to 10,000 mD (e.g., from 26 mD to 500 mD, from 26mD to 600 mD, from 26 mD to 700 mD, from 26 mD to 800 mD, from 26 mD to 900 mD, from 26 mD to 1,000 mD, from 26 mD to 2,000 mD, from 26 mD to 3,000 mD, from 26 mD to 4,000 mD, from 26 mD to 5,000 mD, from 26 mD to 10,000 mD, from 100 mD to 1,000 mD, or from 200 mD to 800 mD). For a reservoir that includes heavy oil, the permeability of that reservoir may be from 200 mD to 800 mD. For a reservoir that includes gas, the permeability of that reservoir may be from 26 mD to 700 mD.

As used herein, in some embodiments, a reservoir may have a permeability from 0.0000001 mD to 10,000 mD.

When referring to a permeability value of a reservoir, the permeability value may comprise an average value for the permeability of samples across a portion of the reservoir. A person of ordinary skill in the art will appreciate that these permeability values are not meant to be limiting, and they are included as non-limiting examples.

The term reservoir may sometimes be used synonymously with the term “subsurface reservoir” or “subsurface formation” or “subsurface formation” or “subsurface volume of interest” or “subterranean formation” or “subsurface” or the like. Indeed, the terms “hydrocarbon”, “reservoir”, and the like are not limited to any description or configuration described herein.

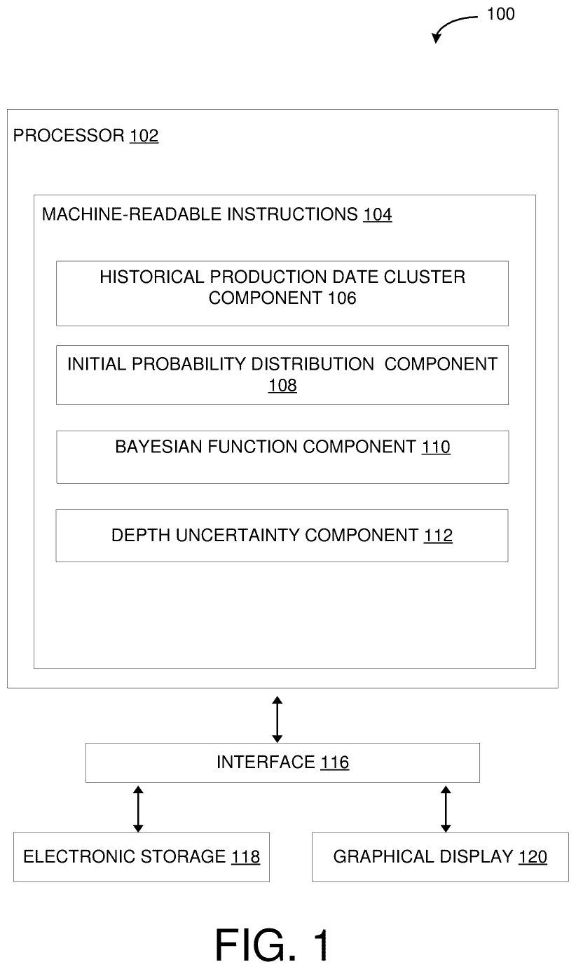

FIG. 1 illustrates an example system 100 incorporating the systems and methods described above. The electronic storage 118 may be configured to include an electronic storage medium that electronically stores information. The electronic storage 118 may store software algorithms, information determined by the processor 102, information received remotely, and/or other information that enables the system 100 to function properly. For example, electronic storage 118 may store information relating to seismic data, and/or other information. The electronic storage media of electronic storage 118 may be provided integrally (i.e., substantially non-removable) with one or more components of the system 100 and/or as removable storage that is connectable to one or more components of the system 100 via, for example, a port (e.g., a USB port, a Firewire port, etc.) or a drive (e.g., a disk drive, etc.). The electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 118 may be a separate component within system 100, or electronic storage 118 may be provided integrally with one or more other components of system 100 (e.g., processor 102). Although electronic storage 118 is shown in FIG. 1 as a single entity, this is for illustrative purposes only. In some implementations, electronic storage 118 may include a plurality of storage units. These storage units may be physically located within the same device, or electronic storage 118 may represent storage functionality of a plurality of devices operating in coordination.

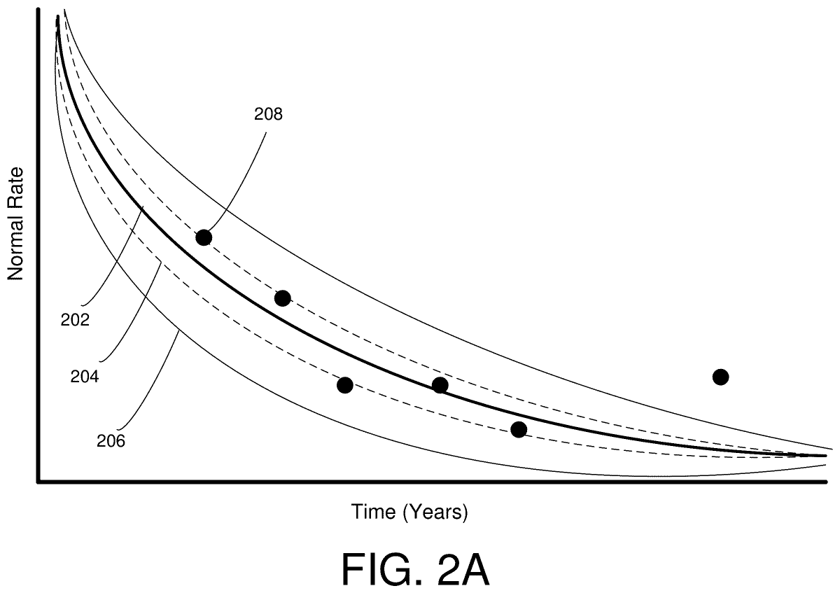

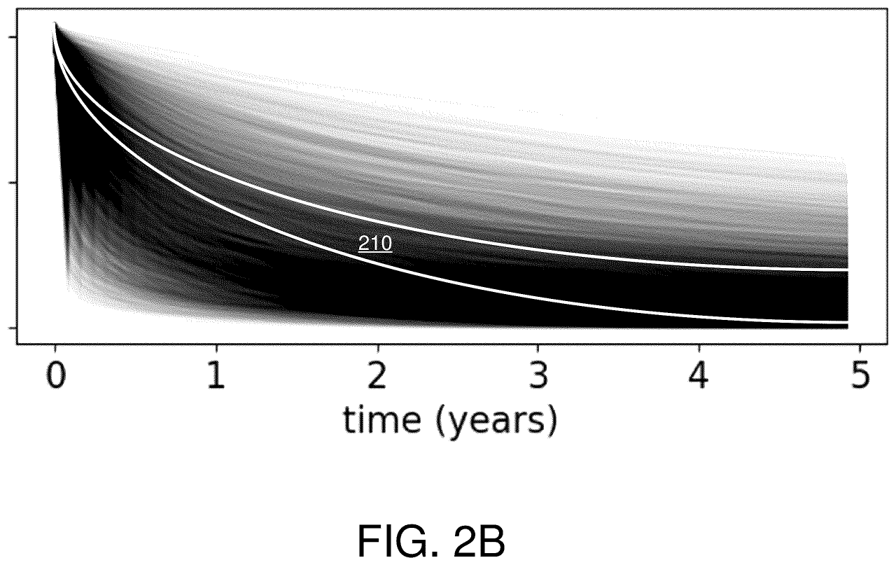

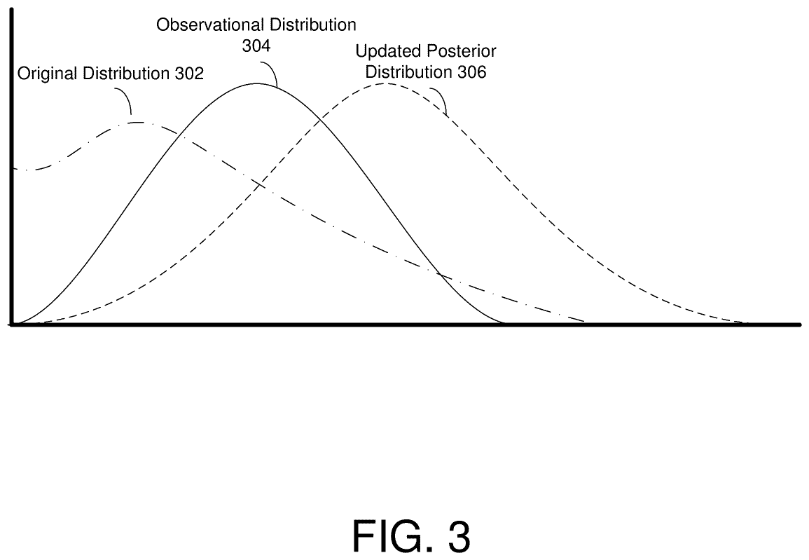

Graphical display 120 may refer to an electronic device that provides visual presentation of information. Graphical display 120 may include a color display and/or a non-color display. Graphical display 120 may be configured to visually present information. Graphical display 120 may present information using/within one or more graphical user interfaces. For example, graphical display 120 may present information relating to seismic data, seismic picks, and/or other information. Graphical display 120 may present information including, but not limited to, graphical representations of depth uncertainty as described below in FIGS. 2A-2B and 3.

Processor 102 may be configured to provide information processing capabilities in the system 100. As such, processor 102 may include one or more of a digital processor, an analog processor, a digital circuit designed to process information, a central processing unit, a graphics processing unit, a microcontroller, an analog circuit designed to process information, a state machine, and/or other mechanisms for electronically processing information. Processor 102 may be configured to execute one or more machine-readable instructions 104 to facilitate seismic event picking. Machine-readable instructions 104 may include one or more computer program components. Machine-readable instructions 104 may include a historical production data cluster component 106, initial probability distribution component 108, a Bayesian function component 110, a depth uncertainty component 112, a characterization/identification component 114, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may include instructions which may program processor 102 and/or system 100 to perform the operation.

While computer program components are described herein as being implemented via processor 102 through machine-readable instructions 104, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 104, historical production data cluster component 106 may be configured to receive historical production data as a function of time for a well, including well parameters and conditions for the well. As described above, well parameters may include, but are not limited to, initial flow, initial decline, minimum decline, and/or a deceleration factor. In some embodiments, the deceleration factor may refer to the modulation of effective decline for a well over time to achieve a minimum decline. In some example, the historical production data, well parameters, and/or conditions may be obtained from multiple wells at different points in time. In some embodiments, historical production data cluster component may smooth the obtained historical production data. In some examples, the smoothing may be performed using a Savitzky-Golay function, a splining function, a wavelet function, Laplacian smoothing, regression, a moving average, a stretched grid, a Kolmogorov filter, a kernel smoother, a Kalman filter, a Butterworth filter, or other smoothing techniques.

Historical production data cluster component 106 may also cluster the historical production data into clusters, with each cluster corresponding to a region in the reservoir. As used herein, a region may include a portion of a hydrocarbon producing basin of interest with a discernable boundary based on observable geologic constraints and/or production behavior. For example, geologic constraints may include structural features such as sub-basins, fault blocks, hydrocarbon maturity, porosity, pore saturation, organic richness, or depositional environments, or any discernable diagenetic overprint on the reservoir rocks. By clustering the historical production data by region, patterns and grouping may be discerned within the data that may indicate different states or types of production flow. Clustering may include clustering the smoothed historical well production data as a function of time by average production rate, peak production rate, and/or productivity index across some or all wells. For example, 50 clusters/region may be used for 10,000 wells of a first reservoir having a permeability of less than 0.1 mD using an automatic clustering process. The automatic clustering may be performed using k-means, spatial clustering, unsupervised clustering, or other clustering methods.

Initial probability distribution component 108 may be configured to generate decline curves from various starting points of the data. An initial probability distribution may be generated for each cluster as a corresponding decline curve model. As described above, distributions may be informed by SME data. The initial factors and parameters may be derived either from distributions observed in manual decline inventories or from other machine learning models that predict these variables from production, engineering and/or subsurface predictors, such as completion size and reservoir. All possible combinations of the prior distributions may be included when evaluating all wells.

Bayesian function component 110 may be configured to iteratively apply a Bayesian function to each initial probability distribution to generate a posterior probability distribution. In some examples, the method further includes selecting a starting point for each well by choosing a point with the smallest normalized error for the posterior probability distribution. Bayesian function component 110 may also be configured to generate a graphical representation of the posterior distribution for each well. Depth uncertainty component 112 may be configured to quantify uncertainty for the well production values across one or more wells based on the posterior probability distribution.

FIGS. 2A and 2B illustrate an example updated decline curve in accordance with one embodiment. For these figures, time is represented on the horizontal axis, while normal rate is represented on the vertical axis. The bold line 202 illustrates the updated decline curve for a particular well. The area between dashed lines 204 illustrate the area of uncertainty for the decline curve based on previous analyses, tests, and the Bayesian statistical characterization of decline curve 202. As more data is added or updated, area between lines 204 may shrink to illustrate decreased uncertainty. The area between solid lines 206 illustrate the area of previous tests, observations, and the initial probability distributions. As illustrated by FIG. 2A, the system described above in FIG. 1 evaluates all of these initial distributions and narrows the uncertainty area. Points 208 illustrate outliers in the decline curves. As described above, the data may be normalized to remove these outliers. FIG. 2B illustrates another example of this type of graphical representation with the overlay of every initial probability distribution (indicated by the plurality of black lines). Area 210 represents the updated area for the decline curve including the area of uncertainty as described above for FIG. 2A.

FIG. 3 represents plots of statistical well production distributions across multiple wells, consistent with embodiments disclosed herein. The vertical axis of the plots represents well production. As illustrated in FIG. 3, an original distribution 302 may be estimated based on well parameters across multiple wells. The original distribution 302 may be informed by observations of the performance of similar real-world wells and/or experiments. For example, the ARPS equation may be applied to well parameters, including engineering and/or subsurface predictors such as completion size and reservoir, to estimate initial decline (di) and b-factors. The estimated well performance for each well may be correlated to well parameters based on observations and/or subsurface subject-matter expert beliefs about well performance based on well parameters and conditions of the respective wells. The estimated well performances may then be stored in a well estimates database together with well parameters and conditions. The estimated well performances may also be plotted in original distribution 302 to quantify the probability about how a well with a particular set of well parameters and conditions will perform.

Real-world data may then be used to produce the observational distribution 304, which shows historical well production distribution across multiple wells. Each well has a unique set of well parameters and may have been exposed to a known set of operational conditions. Observational distribution 304 includes historical well performance data from those real-world wells. The well parameters and conditions for each well may be collected and stored in a historical database together with the historical well performance data.

In some examples, the method may be applied by obtaining raw historical well production data as a function of time for a large number of wells (e.g., 10,000 wells) from the first reservoir having a permeability of less than 0.1 mD or a lessor number of wells (e.g., 100 wells) from a second reservoir having a permeability higher than the permeability of the first reservoir. As used herein, production time data may include production rate time, i.e., well fluid and gas production rates recorded periodically with time, such as daily barrels/day.

The observational distribution 304 may then be used to update the estimated distribution 302 based on well production data and conditions. For example, the historical well parameters and conditions may be compared to and correlated with the well parameters and conditions from the estimated well performance data. The correlations may be used to facilitate the comparison of similar estimated well performance data and the historical well performance data for similar real-world wells under similar operational conditions to modify the estimated well performance data, resulting in a calculated posterior distribution 306. This process may be iterated to update the model fit. Following this approach enables continuous improvement to the model by updating the existing model with real-world data as it is obtained.

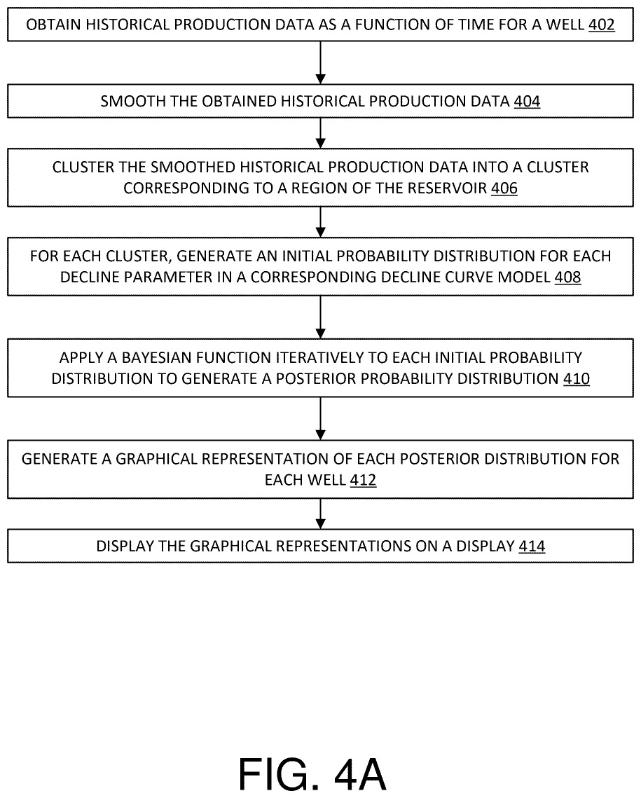

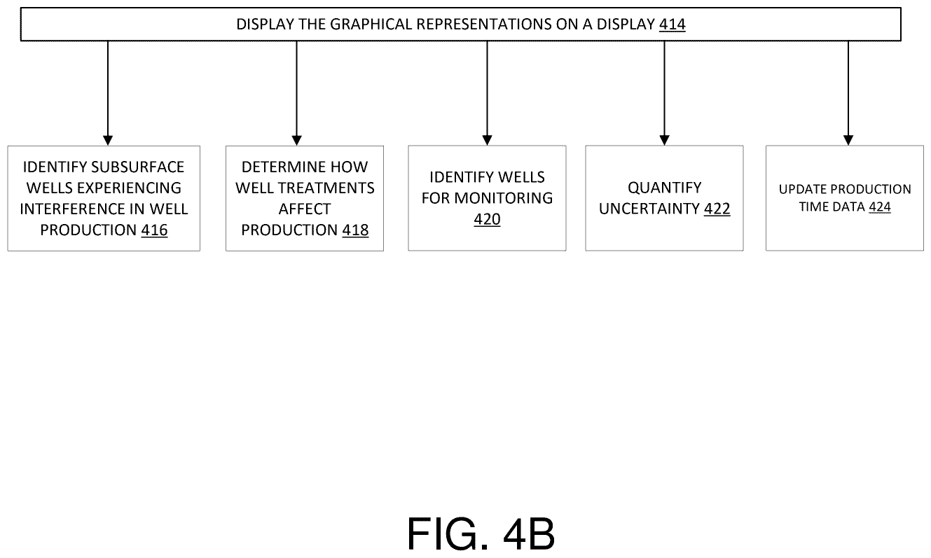

FIG. 4a is a flow chart of a method for generating a posterior distribution 306 consistent with embodiments disclosed herein. For example, the method may include obtaining historical production data as a function of time for a well at step 402. The method also includes obtaining well parameters and conditions for the well. In some example, the historical production data, well parameters, and/or conditions may be obtained from multiple wells at different points in time.

The method may include smoothing the obtained historical production data at step 406. In some examples, the smoothing may be performed using a Savitzky-Golay function, a splining function, a wavelet function, Laplacian smoothing, regression, a moving average, a stretched grid, a Kolmogorov filter, a kernel smoother, a Kalman filter, a Butterworth filter, or other smoothing techniques.

In the example of the use of historical well data from the 10,000 wells of the first reservoir, the smoothing step may include applying time correction to translate historical production volumes into historical production rates and production downtimes. The smoothing step may be used to remove outliers. The smoothing may further include applying a rolling average and/or a low-pass filter to the well production data over time for each of the 10,000 wells of the first reservoir.

As further shown in FIG. 4A, the method may include clustering the historical production data into clusters, with each cluster corresponding to a region in the reservoir at step 406. In some embodiments, the region may be based on geology of the reservoir or a spatial cluster analysis of well production. In some examples, the clustering may be performed on the smoothed historical production data from step 404. In some examples, the clustering may be performed based on rate data. By clustering the historical production data by region, patterns and grouping may be discerned within the data that may indicate different states or types of production flow. Inputs for the clustering step 406 may include b-factor, di-factor, and production time. In some examples, the production time may be transformed or normalized to improve data fitting. The data fitting may be performed using machine learning or Markov Chan Monte Carlo processes. The data fitting process will reduce, and potentially minimize the sum of squared residuals. In some embodiments, the method may further comprise aggregating a plurality of posterior probability distributions corresponding to the clusters to generalize an EUR for a region of interest.

In the example of the use of historical well data from 10,000 wells of the first reservoir, the clustering step may include clustering the smoothed historical well production data as a function of time by average production rate, peak production rate, and/or productivity index for the 10,000 wells of the first reservoir. For example, 50 clusters/region may be used for the 10,000 wells of the first reservoir using an automatic clustering process. In the example of the use of historical well data from 100 wells of the second reservoir, a smaller number of clusters per region may be used (e.g., 5 clusters/region).

In other examples, in the context of a reservoir having a permeability of less than 0.1 mD, more than 50 clusters/regions may be utilized. The quantity of regions/clusters in this context may depend on well density (samples) and expectations of precision, and the upper limit may be on the order of 1,000 clusters/regions.

In other examples, in the context of a reservoir having a higher permeability such as the second reservoir, about 3-5 clusters/regions may be utilized (e.g., 3 clusters/regions may be utilized, 4 clusters/regions may be utilized, or 5 clusters/regions may be utilized).

The automatic clustering may be performed using k-means, spatial clustering, unsupervised clustering, or other clustering methods. The clustering may alternatively be performed manually using maps and/or 3-dimensional geological models that identify different regions. In some examples, the method may use static data for clustering, such as spatial coordinates, depths, depositional environments, petrophysical proxies, and the like.

As used herein, a region may include a portion of a hydrocarbon producing basin of interest with a discernable boundary based on observable geologic constraints and/or production behavior. For example, geologic constrains may include structural features such as sub-basins, fault blocks, hydrocarbon maturity, porosity, pore saturation, organic richness, or depositional environments, or any discernable diagenetic overprint on the reservoir rocks.

The method may also include generating decline curves from various starting points. For example, constraints may be applied to b-factor and di-factor parameters based on observed variations from historical data from hydrocarbon production basins. The decline curves may be normalized, e.g., by dividing the sum of square errors by the number of data points in the set. In some examples, a Bessel's correction may be applied.

The method may include generating, for each cluster, an initial probability distribution for each decline parameter in a corresponding decline curve model at step 408. The method may also include iteratively applying a Bayesian function to each initial probability distribution to generate a posterior probability distribution 306 at step 410. Applying the Bayesian function iteratively may involve comparing each initial probability distribution to all initial probability distributions. In some examples, the method further includes selecting a starting point for each well by choosing a point with the smallest normalized error for the posterior probability distribution.

In the example of the use of historical well data from 10,000 wells of the first reservoir, the generation of an initial probability distribution may include using an ARPS decline curve model with, e.g., three parameters to generate three initial probability distributions for each cluster/region, resulting in 30,000 initial probability distributions. The 30,000 posterior probability distributions may then be used to estimate 10,000 Estimated Ultimate Recovery (EUR). As used herein, an EUR represents the integration of production rate over time for the expected life of the well, or the expected total hydrocarbon production from the well during its lifetime.

The method may further include generating a graphical representation of the posterior distribution for each well at step 412. In some examples, the method may include displaying the graphical representation on a display at step 414.

FIG. 4B illustrates a block diagram of a workflow for applying the resulting display of the graphical representation of the posterior distributions from step 414. In some embodiments, the graphical representation displayed at step 414 may be applied by identifying subsurface wells experiencing interference in well production at step 416. For example, if well production deviates by a statistically significant margin from the expected well production within the posterior distribution for a given time along a decline curve, the well may be flagged for potential interference. For example, if hydrocarbon flow unexpectantly diverts from the well to a neighboring well, the well production may drop below the expected production on the decline curve as expected based on the posterior distribution as generated in step 410. The threshold for determining whether such interference has occurred may be determined based on a well production drop of one, two, three, or more standard deviations from the expected well production at a given time along the decline curve.

As further illustrated in FIG. 4b, the method may be applied to determine how well treatments may affect well production at step 418. For example, if well production falls below the expected well production and a well treatment plan is applied, the effectiveness of the well treatment plan may be determined to be successful if the well production returns to a level within an acceptable threshold of the expected well production for a given time along the decline curve. In some examples, this threshold may be a well production within three, two, or one standard deviations of the expected well production. In some embodiments, the method may further include identifying at least one well that is a candidate for manual examination of its corresponding decline curve. In some embodiments, the method may further comprises identifying at least one well that is statistically not likely to be a candidate for manual examination of its corresponding decline curve. In the Bayesian approach, a prior belief of the probability distribution of key decline curve analysis parameters may be established. A good basis of this probability distribution is to have at least several wells to manually decline to postulate an initial probability distribution. The method may also include using a population of wells to build a series of decline curve analysis to sample to prior belief parameters to build a posterior probability distribution. The prior and the posterior probability distributions may be merged, and the resulting new probability distribution may then iteratively made the prior to another round of analysis until a stable likelihood distribution is converged upon. In some embodiments, operational data may be obtained for the well. The operational data may include operational events such as surfactant injections, acid injections, hydraulic fracturing of the well (at some proximity), or other events. In some embodiments, operational events may also include well treatment events. The event may also include a unique well identifier such as the time/data of the event or the duration of the event. For each operational event, the method may compare the EUR before and after the event to determine an effect of the operational event based on the comparison. Comparisons may be based on the similarity index, p-value, and/or z-score for the event. Any statistical comparison may be applied that may allow rejection of the null hypothesis to indicate statistical significance. The system may generate an indication representing whether or not each event had an effect on EUR for the well. In some embodiments, the method may be applied to determine how the operational events are affecting well production.

The method may also be applied to identify target wells for monitoring at step 420. For example, if one or more wells begin to show well production values that deviate statistically from the expected well production value along their respective decline curves for a given time, as determined based on the methods disclosed herein, then those wells may be flagged for further monitoring to determine if the well production observations are outliers, or if they continue and require further attention. In some embodiments, the method may be applied to identify wells that experience fracture driven interaction. A fracture driven interaction (FDI) may be identified by a near instantaneous change in production rate (e.g., based on daily production rate data), usually within a day to week of a new nearby hydraulic fracture operation (child well). Nearby is within 2 miles of the established, already producing well (parent well). Instantaneous change in production rate may be anything readily noticeable by human operator, often triggered computationally by more than 10% change in production rate. In other embodiments, the method may be applied to identify a future time interval to update production time data for each region based on changes in uncertainty during the future time interval.

In some examples, the method may be applied by quantifying uncertainty for the well production values across one or more wells at step 422. The method may also be applied to update production time data at step 424.

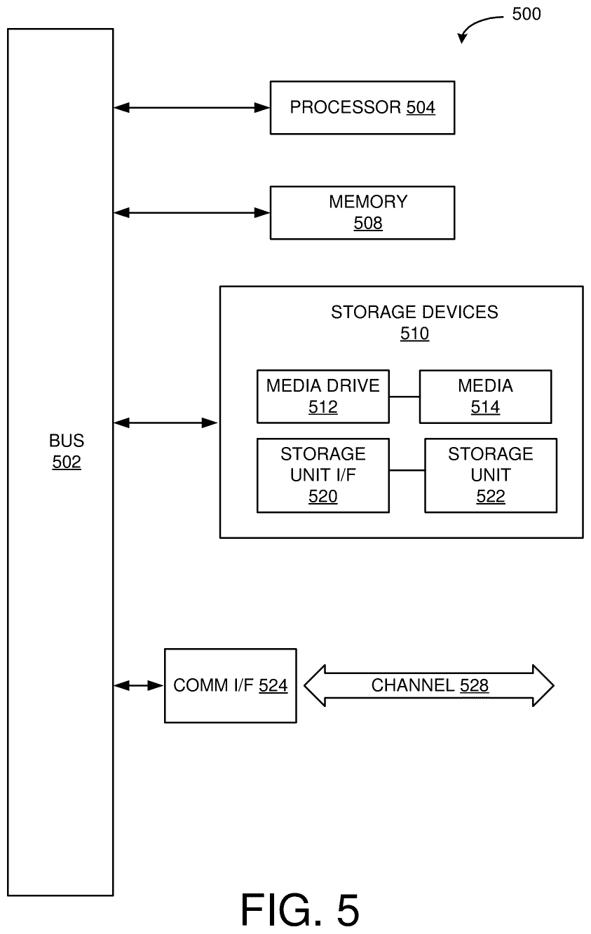

As used herein, the terms circuit and component might describe a given unit of functionality that may be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features may be shared in part or in total among one or more components. In other words, as would be apparent to one of ordinary skill in the art after reading this description, the various features and functionality described herein may be implemented in any given application. They may be implemented in one or more separate or shared components in various combinations and permutations. Although various features or functional elements may be individually described or claimed as separate components, it should be understood that these features/functionalities may be shared among one or more common software and hardware elements. Such a description shall not require or imply that separate hardware or software components are used to implement such features or functionality.

Where components are implemented in whole or in part using software, these software elements may be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium may be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 may include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 may include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or another interface). Other examples include a communications port (such as for example, a USB port, IR port, RS232 port Bluetooth® interface, or other port), or another communications interface. Software/data transferred via communications interface 524 may be carried on signals, which may be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they may be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. Terms of similar meaning should not be construed as limiting the item described to a given time period or to an item available as of a given time, such as the terms and adjectives “conventional,” “traditional,” “normal,” “standard,” and/or “known. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, may be combined in a single package or separately maintained and may further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

It is understood that when combinations, subsets, groups, etc. of elements are disclosed (e.g., combinations of items in a composition, or combinations of steps in a method), that while specific reference of each of the various individual and collective combinations and permutations of these elements may not be explicitly disclosed, each is specifically contemplated and described herein. By way of example, if an item is described herein as including an item of type A, an item of type B, an item of type C, or any combination thereof, it is understood that this phrase describes all of the various individual and collective combinations and permutations of these items. For example, in some embodiments, the item described by this phrase could include only an item of type A. In some embodiments, the item described by this phrase could include only an item of type B. In some embodiments, the item described by this phrase could include only an item of type C. In some embodiments, the item described by this phrase could include an item of type A and an item of type B. In some embodiments, the item described by this phrase could include an item of type A and an item of type C. In some embodiments, the item described by this phrase could include an item of type B and an item of type C. In some embodiments, the item described by this phrase could include an item of type A, an item of type B, and an item of type C. In some embodiments, the item described by this phrase could include two or more items of type A (e.g., A1 and A2). In some embodiments, the item described by this phrase could include two or more items of type B (e.g., B1 and B2). In some embodiments, the item described by this phrase could include two or more items of type C (e.g., C1 and C2). In some embodiments, the item described by this phrase could include two or more of a first item (e.g., two or more items of type A (A1 and A2)), optionally one or more of a second item (e.g., optionally one or more items of type B), and optionally one or more of a third item (e.g., optionally one or more items of type C). In some embodiments, the item described by this phrase could include two or more of a first item (e.g., two or more items of type B (B1 and B2)), optionally one or more of a second item (e.g., optionally one or more items of type A), and optionally one or more of a third item (e.g., optionally one or more items of type C). In some embodiments, the item described by this phrase could include two or more of a first item (e.g., two or more items of type C (C1 and C2)), optionally one or more of a second item (e.g., optionally one or more items of type A), and optionally one or more of a third item (e.g., optionally one or more items of type B).

What is claimed is:

1. A computer-implemented method for performing decline curve analysis, the method comprising:
obtaining historical production data as a function of time for at least one well drilled into a reservoir;
smoothing the obtained historical production data;
clustering the smoothed historical production data into at least one cluster corresponding to a region of the reservoir;
for the region, generating an initial probability distribution for each decline parameter in a corresponding decline curve model;
applying a Bayesian function iteratively to each initial probability distribution to generate a posterior probability distribution for each decline parameter to estimate an expected ultimate recovery (EUR) for each well;
generating a graphical representation of each posterior distribution for each well, wherein the graphical representation indicates uncertainty of each EUR over time; and
displaying the graphical representations on a display.

2. The computer-implemented method of claim 1, further comprising aggregating a plurality of posterior probability distributions corresponding to a plurality of clusters to generalize an EUR for a region of interest.

3. The computer-implemented method of claim 1, further comprising identifying at least one well that experienced fracture driven interaction.

4. The computer-implemented method of claim 1, further comprising determining how operational events to the at least one well are affecting well production.

5. The computer-implemented method of claim 1, further comprising identifying at least one well that is a candidate for manual examination of its corresponding decline curve.

6. The computer-implemented method of claim 1, further comprising identifying at least one well that is statistically not likely to be a candidate for manual examination of its corresponding decline curve.

7. The computer-implemented method of claim 1, further comprising quantifying uncertainty for each region.

8. The computer-implemented method of claim 1, wherein the region is based on geology of the reservoir or a spatial cluster analysis of well production.

9. The computer-implemented method of claim 1, further comprising identifying a future time interval to update production time data for each region based on changes in uncertainty during the future time interval.

10. The computer-implemented method of claim 1, wherein applying the Bayesian function iteratively to each initial probability distribution involves comparing each initial probability distribution to all initial probability distributions.

11. A system for subsurface characterization from seismic gather data comprising:
a processor;
a display; and
a memory encoded with instructions, which when executed by the processor, cause the processor to:
obtain historical production data as a function of time for at least one well drilled into a reservoir;
smooth the obtained historical production data;
cluster the smoothed historical production data into at least one cluster corresponding to a region of the reservoir;
for the region, generate an initial probability distribution for each decline parameter in a corresponding decline curve model;
apply a Bayesian function iteratively to each initial probability distribution to generate a posterior probability distribution for each decline parameter to estimate an expected ultimate recovery (EUR) for each well;
aggregating a plurality of posterior probability distributions corresponding to a plurality of clusters to generalize an EUR for a region of interest;
generate a graphical representation of the aggregated plurality of posterior probability distributions; and
display the graphical representations on the display.

12. The system of claim 11, wherein the processor is further configured to determine how operational events to the at least one well are affecting well production.

13. The system of claim 11, wherein the processor is further configured to identify at least one well that is a candidate for manual examination of its corresponding decline curve.

14. The system of claim 11, wherein the processor is further configured to identify at least one well that is statistically not likely to be a candidate for manual examination of its corresponding decline curve.

15. The system of claim 11, wherein the processor is further configured to quantify uncertainty for each region.

16. The system of claim 11, wherein the region is based on geology of the reservoir or a spatial cluster analysis of well production.

17. A non-transitory machine-readable storage medium encoded with instructions, which when executed by a processor, cause the processor to:
obtain historical production data as a function of time for at least one well drilled into a reservoir;
smooth the obtained historical production data;
cluster the smoothed historical production data into at least one cluster corresponding to a region of the reservoir;
for the region, generate an initial probability distribution for each decline parameter in a corresponding decline curve model;
apply a Bayesian function iteratively to each initial probability distribution to generate a posterior probability distribution for each decline parameter to estimate an expected ultimate recovery (EUR) for each well;
quantify uncertainty for each posterior probability distribution;
generate a graphical representation of each posterior distribution and its uncertainty for each well; and
display the graphical representations on a display.

18. The non-transitory machine-readable storage medium of claim 17, wherein the processor is further configured to identify at least one well that is a candidate for manual examination of its corresponding decline curve.

19. The non-transitory machine-readable storage medium of claim 17, wherein the processor is further configured to identify at least one well that is statistically not likely to be a candidate for manual examination of its corresponding decline curve.

20. The non-transitory machine-readable storage medium of claim 17, wherein the region is based on geology of the reservoir or a spatial cluster analysis of well production.
